(19) United States
(12) Patent Application Publication
(10) Pub. No.: US 2004/0179540 A1
(43) Pub. Date: Sep. 16, 2004

(54) Universal multi-media gateway

(76) Inventors: Chang-Hung Lee, Dounan Township (TW); Heng-Cheng Chu, Taichung City (TW); Cheng-Te Tseng, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/785,571

(22) Filed: Feb. 24, 2004

(30) Foreign Application Priority Data
Mar. 11, 2003 (TW) 092105279

(51) Int. Cl. H04L 12/56

(52) U.S. Cl. 370/401; 370/338; 370/315

(57) ABSTRACT

A universal multi-media gateway includes a media processor, a first media access control layer (MAC Layer), a switch device, a second MAC layer, a wireless transmitter and a physical layer. The media processor is used for receiving media signals and is coupled to the first MAC layer and is coupled to the switch device the first MAC layer. The second MAC layer is coupled to the switch device; the wireless transmitter is coupled to the second MAC layer. The physical layer is coupled to the switch device and also coupled to an external Ethernet network. This universal multi-media gateway can substitute for a wireless LAN access point, a wireless media sharing device and a media server by switching the switch device to different switching statuses.

This application claims the benefit of Taiwan application No. 92105279, filed Mar. 11, 2003.

### BACKGROUND OF THE INVENTION

1. Field of the Invention

The invention relates in general to a universal multi-media gateway, and more particularly to a gateway which is possessed of the functions as a wireless local area network access, a wireless media sharing and a media server.

2. Description of the Related Art

Developments in internet and wireless communication technologies nowadays have made a data service device or a audio-visual service device generally including as follow:

1. A wireless local area network (LAN) access point, including a media access control layer (MAC layer), a physical layer (PHY layer) and a wireless local area network (LAN) transmitter. The PHY layer is coupled to an external Ethernet network. The data packets from the external Ethernet network are converted to wireless signals by the PHY layer, the MAC layer and the wireless LAN transmitter, and the wireless signals are transmitted to the electronic products equipped with a wireless receiver. Thus, the electronic products could access to the external Ethernet network by wireless communication through the wireless LAN access point.

2. A wireless media sharing device, including a media processor and a wireless LAN transmitter. The media processor is used for receiving media signals from an audio-video providing device such as a video compact disc player (VCD player), a digital versatile disc player (DVD player), a cable television system or a frequency modulation (FM) broadcast system. The media signals will be transmitted in a wireless signal format by the wireless LAN transmitter to the nearby electronic products equipped with a wireless receiver, such as a notebook or a personal digital assistant (PDA). Thus, a user can move everywhere at home from any location and choose any TV or broadcast programs freely by wireless communication through the wireless media sharing device.

3. A media server, including a media processor, a MAC layer and a PHY layer. The media processor receives media signals from an audio-video providing device and then the media signals will be transmitted in data packets format by the MAC layer and PHY layer. Electronic products which connect to with the media servers can receive these media signals through the wired network.

Owing to the distinction between the data or the audio-visual service devices, users have to buy all three above-mentioned devices simultaneously to fulfill various needs. There has therefore been a demand for gateway manufacturers today to fabricate a low-cost and more convenient multi-functional media gateway including these above-mentioned functions.

### SUMMARY OF THE INVENTION

It is therefore an object of the invention to provide a universal media gateway which can substitute for a wireless LAN access point, a wireless media sharing device or a media server despite there are merely two MAC layers and a PHY layer included rather than using three above-mentioned devices respectively. As a result, the invention can reach the aim to reduce costs dramatically by simplification of the circuit.

It is another object of the invention to provide a universal media gateway including a media processor, a first media access control layer (MAC layer), a switch device, a second MAC layer, a local area network (LAN) transmitter and a physical layer (PHY layer). The media processor is used for receiving media signals and is coupled to the first MAC layer; the first MAC layer is coupled to the switch device. This switch device is coupled to the second MAC layer; the second MAC layer is coupled to the wireless transmitter. The PHY layer is coupled to the switch device and also coupled to the external Ethernet network.

While the switch advice is in a first switching status, the second MAC layer is coupled to the physical layer so that the data packets from the external Ethernet network can be transmitted to the wireless transmitter via the PHY layer and the second MAC layer. While the switch device is in a second switching status, the first MAC layer is coupled to the second MAC layer so that the media signals can be transmitted to the wireless transmitter via the first and the second MAC layers. Further, while the switch device is in a third switching status, the first MAC layer is coupled to the PHY layer so that the media signals can be transmitted to the external Ethernet network via the first MAC layer and the PHY layer.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a universal media gateway according to a preferred embodiment of the invention;

FIG. 2A is a block diagram of a universal media gateway illustrating the operation when the switch device is switched to a first switching status;

FIG. 2B is a block diagram of a universal media gateway illustrating the operation when the switch device is switched to a second switching status; and

FIG. 2C is a block diagram of a universal media gateway illustrating the operation when the switch device is switched to a third switching status.

### DETAILED DESCRIPTION OF THE INVENTION

The invention uses a switch device enabling the first and second MAC layers and the PHY layer shared so that a universal media gateway can substitute for a wireless LAN access point, a wireless media sharing device and a media server simultaneously.

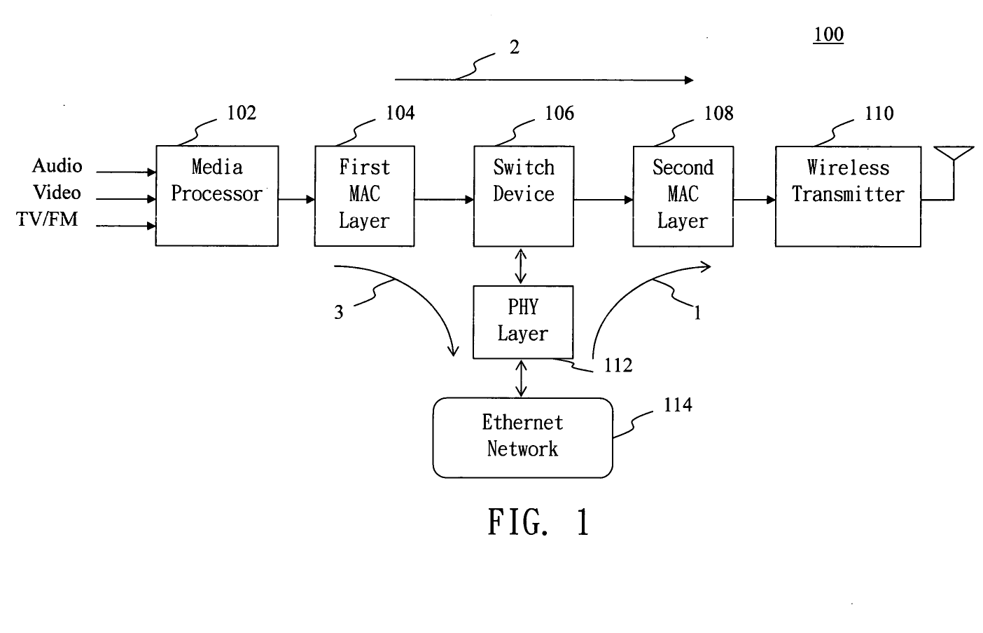

FIG. 1 is a block diagram of a universal media gateway 100 according to the preferred embodiment of the invention. Referring to FIG. 1, the universal media gateway 100 includes a media processor 102, a first access control layer (MAC layer) 104, a switch device 106, a second MAC layer 108, a wireless transmitter 110 and a physical layer (PHY layer) 112. The media processor 102 is used for receiving a media signal and is coupled to the first MAC layer 104. The media signals at least include an audio signal, a video signal, a television signal, or a frequency modulation signal. The switch device 106 is coupled to the first MAC layer 104 and the second MAC layer 108 is coupled to the switch device 106; the wireless transmitter 110 is coupled to the second MAC layer 108. The PHY layer 112 is coupled to the switch device 106 and selectively coupled to an external Ethernet network 114.

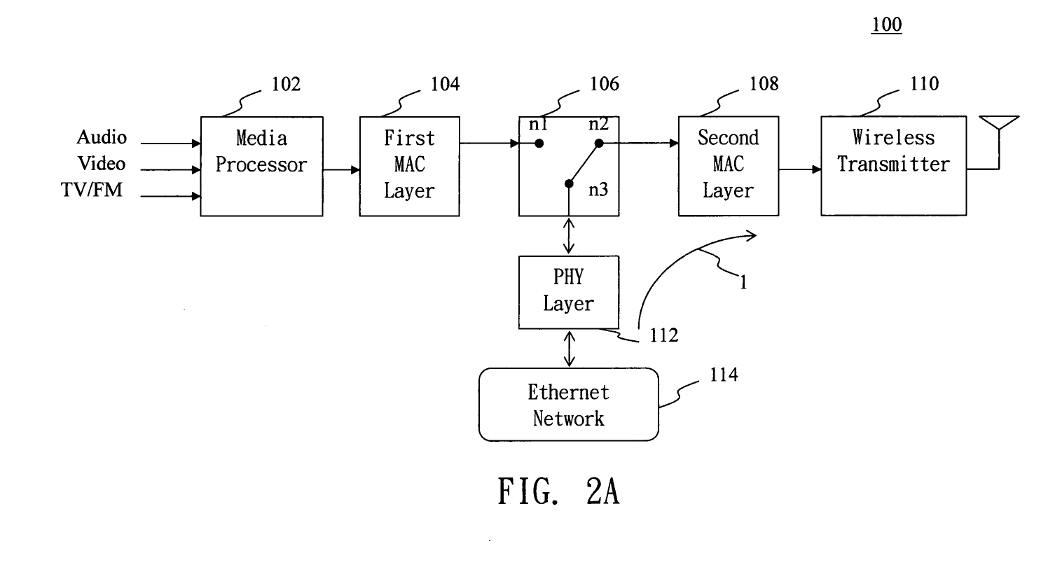

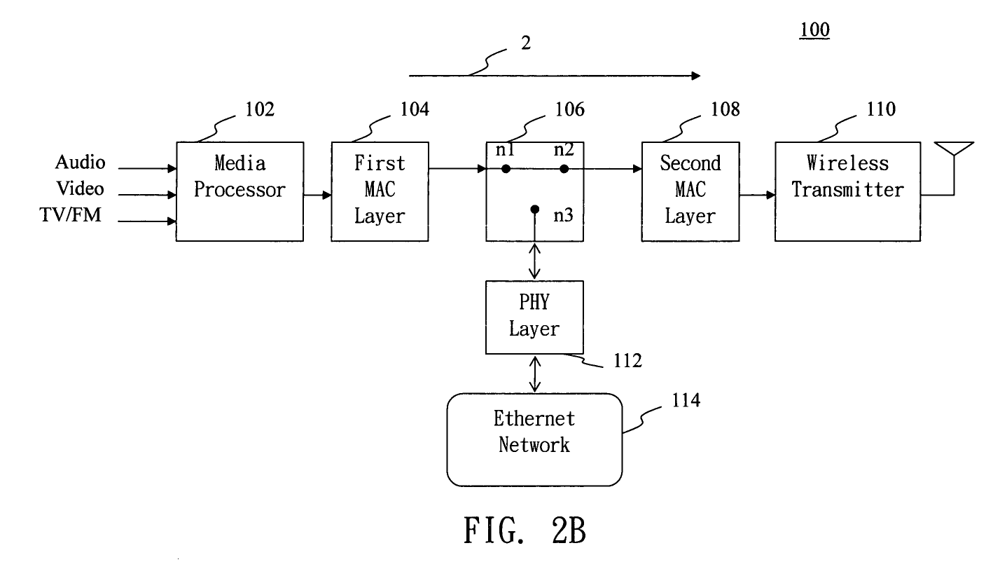

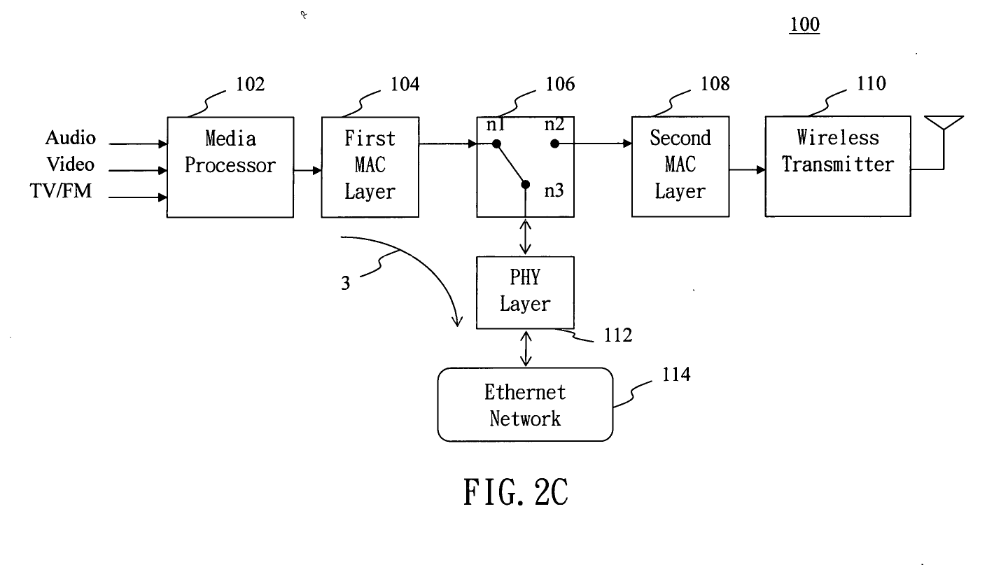

The switch device 106 could be a programmable switch or a mechanical switch and includes three nodes: node n1, node n2 and node n3. The switch device 106 is switched between at least three different switching statuses to allow any two of the nodes to be selectively coupled. FIG. 2A is a block diagram of a universal media gateway 100 illustrating the operation when the switch device is switched to a first switching status. When the switch device is switched to the first switching status, the node n2 and the node n3 of the switch device 106 are electrically coupled to each other, and therefore the PHY layer 112 is electrically coupled to the second MAC layer 108. Consequently, the data packets from the external Ethernet network 114 can be transmitted along the path 1 shown in FIG. 2A to the wireless transmitter 110 via the PHY layer 112 and the second MAC layer 108.

FIG. 2B is a block diagram of a universal media gateway 100 illustrating the operation when the switch device is switched to a second switching status. When the switch device is switched to the second switching status, the node n1 and the node n2 of the switch device 106 are electrically coupled to each other. Therefore, the first MAC layer 104 is electrically coupled to the second MAC layer 108. As a result, media signals can be transmitted along the path 2 shown in FIG. 2B to the wireless transmitter 110 via the first MAC layer 104 and the second MAC layer 108.

FIG. 2C is a block diagram of a universal media gateway 100 illustrating the operation when the switch device is switched to a third switching status. When the switch device is switched to the third switching status, the node n1 and the node n3 of the switch device 106 are electrically coupled to each other, and therefore the first MAC layer 104 is electrically coupled to the PHY layer 112. Consequently, media signals can be transmitted along the path 3 shown in FIG. 2C to the external Ethernet network 114 via the first MAC layer 104 and the PHY layer 112.

The universal multi-media gateway 100 of the invention can substitute for a wireless LAN access points, a wireless media sharing devices and a media servers while the wireless transmitter 110 is replaced by a wireless LAN transmitter. While the switch device 106 is in the first switching status, the data packets from the external Ethernet network 114 can be transmitted to the wireless LAN transmitter via the PHY layer 112 and the second MAC layer 108. Therefore, the universal multi-media gateway 100 is regarded as a wireless LAN access point.

While the switch device 106 is in the second switching status, media signals can be transmitted to the wireless LAN transmitter 110 via the first MAC layer 104 and the second MAC layer 108. The universal multi-media gateway 110 is thus regarded as a wireless media sharing device.

Further, while the switch device is in the third switching status, media signals can be transmitted to the external Ethernet network 114 via the first MAC layer 104 and the PHY layer 112. The universal multi-media gateway 110 is therefore regarded as a media server.

The universal multi-media gateway of the present invention includes merely two MAC layers and a PHY layer but it can substitute for a wireless LAN access point, a wireless media sharing device and a media server. The invention can reduce the cost dramatically by simplification of the circuit compared with the conventional way for using a wireless LAN access point, a wireless media sharing device and a media server individually, which needs two MAC layers, two PHY layers, two media processors and two wireless LAN transmitters totally.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A universal multi-media gateway, comprising:
a media processor for receiving a media signal;
a first media access control (MAC) layer coupled to the media processor;
a switch device having three nodes, any two of the nodes capable to be selectively coupled, the first node of the switch device being coupled to the first MAC layer;
a second MAC layer coupled to the second node of the switch device;
a wireless transmitter coupled to the second MAC layer; and
a physical layer coupled to the third node of the switch device and the physical layer being selectively coupled to an external network,
wherein while the switch device is in a first switching status, the second node and the third node are electrically coupled and the second MAC layer is coupled to the physical layer so that data packets from the external network can be transmitted to the wireless transmitter via the physical layer and the second MAC layer,
wherein while the switch device is in a second switching status, the first node and the second node are electrically coupled and the first MAC layer is coupled to the second MAC layer so that the media signals can be transmitted to the wireless transmitter via the first and the second MAC layers,
wherein while the switch device is in a third switching status, the first node and the third node are electrically coupled and the first MAC layer is coupled to the physical layer so that the media signals can be transmitted to the external network via the first MAC layer and the physical layer.

2. The universal multi-media gateway according to claim 1, wherein the media signals comprise an audio signal, a video signal, a television signal, or a frequency modulation (FM) signal.

3. The universal multi-media gateway according to claim 1, wherein the wireless transmitter is a wireless local area network (LAN) transmitter.

4. The universal multi-media gateway according to claim 1, wherein the switch device is a programmable switch or a mechanical switch.

5. A universal multi-media gateway, comprising:
a media processor for receiving a media signal;
a first MAC layer coupled to the media processor;
a switch device coupled to the first MAC layer;
a second MAC layer coupled to the switch device;
a wireless transmitter coupled to the second MAC layer;
a physical layer coupled to the switch device and selectively coupled to an external network;
wherein by switching the switch device to different switching statuses, the universal multi-media gateway can substitute for a wireless LAN access point, a wireless media sharing device or a media server.

6. The universal multi-media gateway according to claim 5, wherein the second MAC layer is coupled to the physical layer so that the data packets from the external network can be transmitted to the wireless transmitter via the physical layer and the second MAC layer while the switch device is in a first switching status.

7. The universal multi-media gateway according to claim 5, wherein the first MAC layer is coupled to the second MAC layer so that the media signals can be transmitted to the wireless transmitter via the first and the second MAC layers while the switch device is in a second switching status.

8. The universal multi-media gateway according to claim 5, wherein the first MAC layer is coupled to the physical layer so that the media signals can be transmitted to the external network via the first MAC layer and the physical layer while the switch device is in a third switching status.

9. The universal multi-media gateway according to claim 5, wherein the media signals comprise an audio signal, a video signal, a television signal or a FM signal.

10. The universal multi-media gateway according to claim 5, wherein the wireless transmitter is a wireless LAN transmitter.

11. The universal multi-media gateway according to claim 5, wherein the switch device is a programmable switch or a mechanical switch.
